(19) United States
(12) Patent Application Publication
(10) Pub. No.: US 2010/0005244 A1
(43) Pub. Date: Jan. 7, 2010

(54) Device and Method for Storing Data and/or Instructions in a Computer System Having At Least Two Processing Units and At Least One First Memory or Memory Area for Data and/or Instructions

(76) Inventors: Reinhard Weiberle, Vaihingen/Enz (DE); Bernd Mueller, Leonberg-Silberberg (DE); Eberhard Boehl, Reutlingen (DE); Yorck Von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 11/990,252

(22) PCT Filed: Jul. 25, 2006
(86) PCT No.: PCT/EP2006/064629

§ 371 Date: Feb. 27, 2009

(30) Foreign Application Priority Data
Aug. 8, 2005 (DE) 10 2005 037 219.8

(51) Int. Cl. G06F 12/08; G06F 12/00

(52) U.S. Cl. 711/130; 711/149; 711/E12.001; 711/E12.038

(57) ABSTRACT

A device and method for storing data and/or instructions in a computer system having at least two processing units and at least one first memory or memory area for data and/or instructions, wherein a second memory or memory area is included in the device, the device being designed as a cache memory system and equipped with at least two separate ports, and the at least two processing units accessing via these ports the same or different memory cells of the second memory or memory area, the data and/or instructions from the first memory system being stored temporarily in blocks.

### FIELD OF THE INVENTION

The present invention relates to microprocessor systems having a fast buffer (cache) and describes in this context a dual-port cache.

### BACKGROUND INFORMATION

Processors are equipped with caches to accelerate access to instructions and data. This is necessary in light of the ever-increasing volume of data, on the one hand, and, on the other hand, in light of the increasing complexity of data processing using processors that operate at faster and faster speeds. A cache can be used to partially avoid the slow access to a large (main) memory, and the processor then does not have to wait for data to be provided. Both caches exclusively for instructions and caches exclusively for data are known, but also “unified caches,” in which both data and instructions are stored in the same cache. Systems having multiple levels (hierarchy levels) of caches are also known. Such multi-level caches are used to perform an optimal adjustment of the speeds between the processor and the (main) memory by using graduated memory sizes and various addressing strategies of the caches on the different levels.

In a multi-processor system it is common to equip every processor with a cache, or in the case of multi-level caches with correspondingly more caches. However, systems are also known in which multiple caches exist that are addressable by different processors, such as is discussed in U.S. Pat. No. 4,345,309, for example.

If at least to some extent the same instructions, program segments, programs, or data are used in a multiprocessor system having permanently assigned caches for every processing unit, then every processing unit must load this from the main memory into the cache assigned to it. In the process, bus conflicts may arise when two or multiple processors want to access the main memory. This leads to a performance loss in the multiprocessor system. If multiple shared caches exist, each of which may be accessed by more than one processor, and if two processors require the same or even different data from one of these caches, then due to the access conflict, a decision must be made regarding which processor has priority of access and the other processor must inevitably wait. The same applies even for different data and instructions if, for the caches, a bus system is used that permits only one access at a time even to different caches.

If the processors each have one cache permanently assigned to them and if they are additionally capable of being switched to different operating modes of the processor system, in which modes they process either different programs, program segments, or instructions (performance mode); or identical programs, program segments, or instructions, and subject the results to a comparison or a voting (compare mode), then the data or instructions in the parallel caches of every single controller must either be deleted when switching over between the operating modes, or they must be provided with the relevant information for the respective operating mode when the cache is loaded, which information may be stored together with the data. In a multiprocessor system that can switch between different operating modes while in operation it would therefore be particularly advantageous if only one shared (if applicable, hierarchically structured) cache existed and every datum or every instruction were stored there only once, and concurrent access to it were possible. An objective of the exemplary embodiments and/or exemplary methods of the present invention is therefore to design such a memory.

An objective of the exemplary embodiments and/or exemplary methods of the present invention is to provide an exemplary embodiment and methods to optimize the size of the cache.

### SUMMARY OF THE INVENTION

Due to the increased hardware expenditure, the implementation of a cache memory as a dual-port cache is not obvious in known processor systems having one or multiple execution units (single or multiple cores). In the case of a multiprocessor architecture in which multiple execution units (cores, processors) work together in a variable way, that is, in differing operating modes (as described in DE 103 32 700 A1, for example), a dual-port cache architecture may be advantageously implemented. The essential advantage relative to multiprocessor systems having multiple caches is that in the event of a switchover between the operating modes of the multiprocessor system the content of the caches does not have to be deleted or declared invalid, since the data are stored only once and therefore remain consistent even after a switchover.

A dual-port cache in a multiprocessor system having multiple operating modes has the advantage that the data/instructions do not have to be loaded multiple times to the cache and where necessary maintained; in terms of hardware, only one memory location must be provided per datum/instruction, even if this datum/instruction is used by multiple execution units; in different operating modes of the multiprocessor system, the data do not have to be distinguished as to the mode in which they were processed or loaded; the cache does not have to be deleted when the operating mode is switched; two processors may simultaneously have read access to the same data/instructions; instead of the “write-through” mode, a “write-back” mode may also be implemented for the cache, this mode being in particular more time-efficient during writing since the (main) memory does not have to be updated constantly, but rather only when the data in the cache are overwritten; there are no consistency problems since the cache provides the data for both processors from the same source.

A device for storing data and/or instructions in a computer system having at least two processing units and at least one first memory or memory area for data and/or instructions is advantageous, if a second memory or memory area is included in the device, the device being designed as a cache memory system and equipped with at least two separate ports and the at least two processing units accessing identical or different memory cells of the second memory or memory area via these ports, the data and/or instructions from the first memory system being stored temporarily in blocks.

Furthermore, such a device is advantageous if an arrangement is available that is designed such that read access to one memory cell occurs simultaneously via the at least two ports.

Furthermore, it is advantageous if an arrangement is available in the device that is designed such that read access to two different memory cells occurs simultaneously via the at least two ports.

Furthermore, it is advantageous if an arrangement is provided in the device that, in the event of a simultaneous read access to one same or two different memory cells via the at least two ports, delay access via the one port until the access via the other port has concluded.

Furthermore, it is advantageous if in the device an arrangement is provided by which the access addresses at the at least two ports may be compared.

Furthermore, it is advantageous if in the device an arrangement is provided that detect a write access to a memory cell or a memory area via a first port, and prevent or delay the write and/or read access to this memory cell and/or this memory area via a second port until the write access via the first port has ended.

Furthermore, it is advantageous if an arrangement is contained in the device that, in the event of read access via at least one port, check whether the requested data exist in the second memory or memory area.

Furthermore, it is advantageous if in the device an arrangement is provided to address the first memory or memory area and to transfer from this blocks of memory content to the second memory or memory area if the data requested via a first port do not exist in the second memory or memory area.

Furthermore, it is advantageous if in the device an address comparator is provided that ascertains that at least one memory cell from the memory block requested by the first processing unit via the first port is to be accessed via a second port.

Furthermore, it is advantageous if in the device an arrangement is provided that enable access to the memory cell only when the data in the second memory or memory area are updated.

Furthermore, it is advantageous if in the device the second memory or memory area is subdivided into at least two address areas that may be read or written independently of each other.

Furthermore, it is advantageous if in the device an address decoder exists that generates select signals that permit only one port access and prevent or delay, in particular through wait signals, the access of at least one additional port when multiple ports simultaneously access an address area.

Furthermore, it is advantageous if in the device more than two ports are provided, selection devices being provided and the mutually independent address areas being accessed via the selection devices having multiple stages and for this purpose the select signals being transmitted via these stages.

Furthermore, it is advantageous if in the device at least one mode signal exists that switches the access possibilities of the different ports.

Furthermore, it is advantageous if in the device at least one configuration signal exists that switches the access possibilities of the different ports.

Furthermore, it is advantageous if in the device an n-fold associative cache is implemented with the aid of n different address areas.

Furthermore, it is advantageous if in the device an arrangement is provided that, in the event of a write access to a memory cell or a memory area of the second memory, simultaneously write the datum to be written to the first memory or memory area.

Furthermore, it is advantageous if in the device an arrangement is provided that, in the event of a write access to a memory cell or a memory area of the second memory, write the datum to be written to the first memory or memory area following a delay.

A method for storing data and/or instructions in a computer system having at least two processing units and at least one first memory or memory area for data and/or instructions is advantageously described,

wherein in the device a second memory or memory area is contained, the device being designed as a cache memory system and equipped with at least two separate ports, and the at least two processing units accessing identical or different memory cells of the second memory or memory area via these ports, the data and/or instructions from the first memory system being stored temporarily in blocks.

A method is advantageously described, wherein for reading data from the second memory or memory area and/or for writing data to the second memory or memory area via the two ports, processing units access in parallel the same or different memory cells of the second memory or memory area and read an identical memory cell simultaneously via both ports.

A method is advantageously described, wherein addresses that are applied at the two ports are compared.

A method is advantageously described, wherein a write access to the second memory or memory area and/or a memory cell of the second memory or memory area via a first port is detected, and the write access and read access via a second port to this second memory or memory area is prevented and/or delayed until the write access via the first port is finished.

A method is advantageously described, wherein in the event of a read access via at least one port, the system checks whether the requested data and/or instructions exist in a second memory or memory area.

A method is advantageously described, wherein the check is carried out with the aid of the address information.

A method is advantageously described, wherein in the event that the data requested via a first port are not available in the second memory or memory area, the system causes the relevant memory block to be transmitted from the first memory arrangement to the second memory or memory area.

A method is advantageously described, wherein all information regarding the existence of data and/or instructions is updated as soon as the requested memory block has been transferred to the second memory or memory area.

A method is advantageously described, wherein an address comparator ascertains that a second processing unit wants to access at least one memory cell from the memory block requested by the first processing unit.

A method is advantageously described, wherein the access to the above-mentioned memory cell is made possible only when the relevant information about the existence of data and/or instructions has been updated.

A method is advantageously described, wherein the second memory or memory area is subdivided into at least two address areas, and these at least two address areas may be read or written independently of each other via the at least two ports of the second memory or memory area, each port being able to access each address area.

A method is advantageously described, wherein concurrent access to an address area is restricted to exactly one port and all additional access requests via other ports to this address area are prevented or delayed while the first port is accessing it, in particular through wait signals.

A method is advantageously described, wherein in the event of a write access to a memory cell or a memory area of the second memory, the datum to be written is written simultaneously to the first memory or memory area.

A method is advantageously described, wherein in the event of a write access to a memory cell or a memory area of the second memory, the datum to be written is written to the first memory or memory area following a delay.

Other advantages and advantageous embodiments are derived from the features as described herein and of the specification, including the drawings.

### BRIEF DESCRIPTION OF THE DRAWINGS

FIG. 1 shows a dual-port cache for data and/or instructions.

FIG. 2 shows a dual-port cache having additional details.

FIG. 3 shows a device and a method for address transformation.

FIG. 4 shows a division of the dual-port RAM into two subsections that may be operated independently of one another and that are each controlled by two separate select signals from each port during access.

FIG. 5 shows an implementation of a dual-port RAM area by a single-port RAM using a port switchover.

FIG. 6 shows the division of a multiple-port RAM having p ports into multiple partial address areas 1 . . . q that may be processed in parallel.

FIG. 7 shows the implementation of a multi-port RAM area by a single-port RAM using a port switchover.

FIG. 8 shows a division of the RAM areas for the ports as a function of a system state or a configuration.

FIG. 9 shows a division of a multi-port RAM into areas as a function of a system state or a configuration by generation of the relevant select signals.

FIG. 10 shows the division of a multi-port RAM into areas having multi-associative access.

Table 1 shows the generation of four select signals from two address bits by decoding.

Table 2 shows the generation of two select signals, on each port, from an address bit, this generation taking into consideration a system state or configuration signal M.

Table 3 shows the generation of two select signals, on each port, from an address bit, this generation taking into consideration a system state or configuration signal M in another execution.

### DETAILED DESCRIPTION

In the following, a processing unit or execution unit may denote both a processor/core/CPU, as well as an FPU (floating point unit), a DSP (digital signal processor), a co-processor or an ALU (arithmetic logical unit).

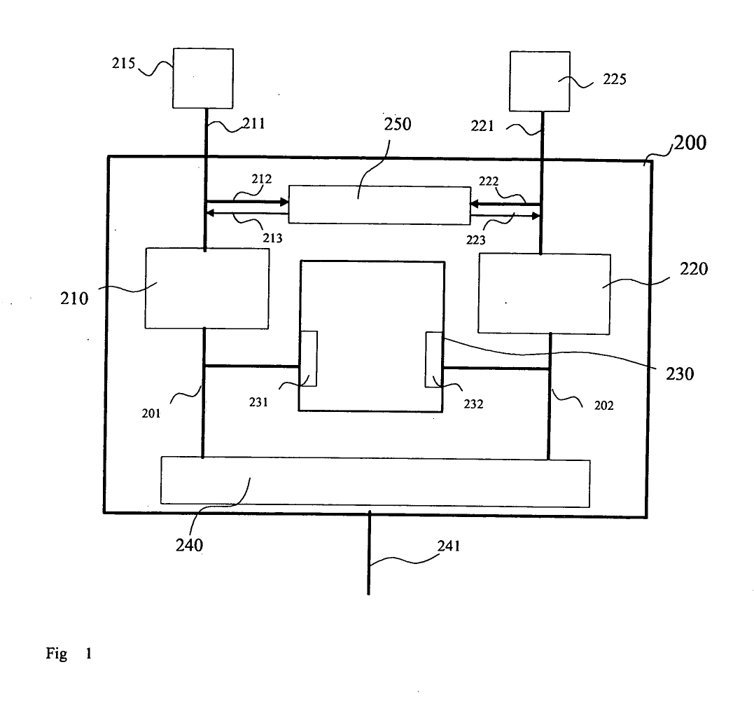

An essential component of the dual-port cache 200 as shown in FIG. 1 is a dual-port RAM (dpRAM, 230). This dpRAM 230 may be provided with two address decoders that are independent of each other, two data read/write stages, and, in contrast to a simple memory cell matrix, also with duplicated word and bit lines so that at least the read operation may take place for any memory cells of the dpRAM from both ports simultaneously. (However, the setup also applies analogously when not all access elements are duplicated, and the dpRAM may therefore be accessed via both ports simultaneously only when certain conditions are met.) Dual-port RAM is therefore understood as any RAM that has two ports 231 and 232 that may be used independently of each other without taking into consideration how much time is required by this port for processing a request to read or write, that is, how long it takes until the requested read or write operation is completed, in some instances also in interaction with requests from the other port. Both ports of the dpRAM are connected via signals 201 and 202 to devices 210 and 220, respectively, which carry out a check of the incoming addresses, data, and control signals 211 and 221, respectively, from independent processing units 215 and 225, and optionally transform the addresses. Depending on the port, the data are output during the read operation via 201 through 210 to 211, or via 202 through 220 to 221, or written to the cache memory by the execution units in the opposite direction in each case. Both ports of the dpRAM are connected via signals 201 and 202 to a bus access control 240 that is connected to signals 241 that create the connection to a (main) memory not shown here or to a cache of the next level.

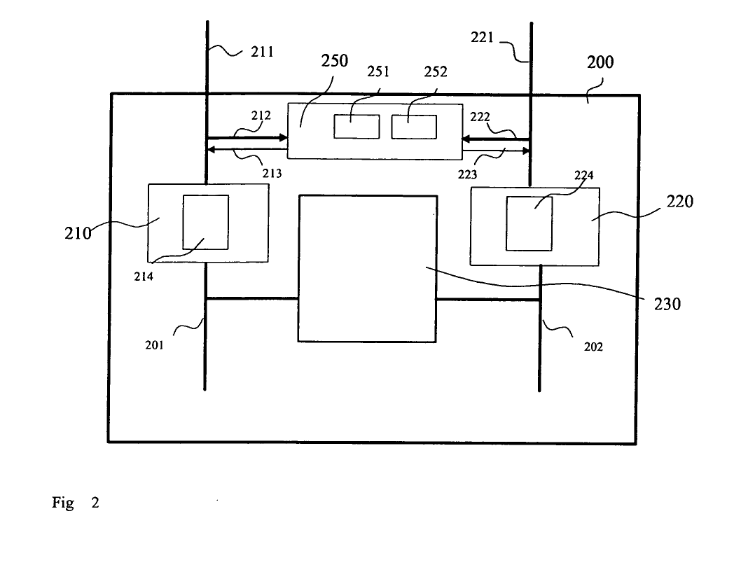

Units 210, 220, and 250 are described in more detail in FIG. 2. During access to the dual-port cache, addresses 212 and 222, contained in signals 211 and 221, of processing units 215 and 225 are compared to each other in an address comparator 251 of device 250 and, together with the control signals likewise transmitted in 211 and 221, checked for compatibility. In the event of a conflict, access to dual-port RAM 230 is prevented using the control signals contained in signals 213 or 223. Such conflicts include both processing units wanting to write to the same address or one processing unit writing to an address that the other wants to read from.

The cache may be executed partially associatively or completely associatively, that is, the data may be stored in multiple or even arbitrary locations of the cache. To enable access to the dpRAM, the address via which the requested data/instructions may be accessed must, to that end, first be determined. Depending on the addressing mode, one or multiple block addresses is/are selected at which the datum is searched for in the cache. All of these blocks are read and the identifier stored with the data in the cache is compared to the index address (part of the original address). Where consistency exists, and after the additional validity check with the aid of the control bits stored for every block likewise in the cache (for example, valid bits, dirty bits, and process ID), a cache hit signal is generated that indicates the validity.

A table may be used for the address transformation, which is located in a memory unit 214 or 224 shown in FIG. 2 (register or RAM, also known as TAG-RAM) in units 210 or 220, respectively. The table is an address transformation unit that both transforms the virtual address into a physical address and, in the case of a direct-mapped cache, provides the exact (unique) cache access address. In the case of a multi-associative cache organization, multiple blocks are accessed, and in the case of a completely associative cache, all blocks of the cache must be read and compared. One such address transformation unit is described in the U.S. Pat. No. 4,669,043, for instance.

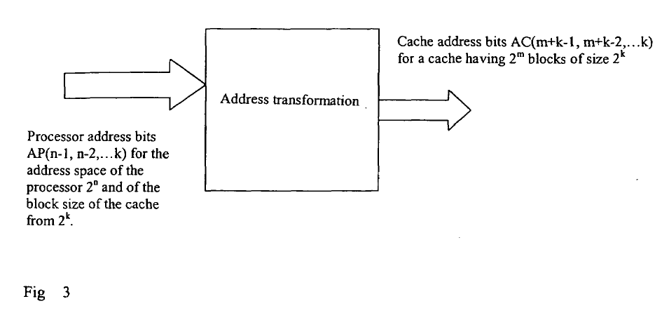

For example, in the above-mentioned table, the access address of the dpRAM is stored for every address or address group of a block. For this purpose, in the addressing type shown in FIG. 3, in accordance with the block size of the cache, the significant address bits (index address) for the table are used as an address and the content is the access address of the dpRAM (FIG. 3). In this context, the number of bytes that, in the case of a cache miss (lack of required data in the cache), are loaded together from the memory and copied to the cache when an address from this area is accessed via read access is described as a block.

For the access to the cache on a byte or word basis, the address bits that are significant for the block are transformed using the table, and the other (less significant) address bits are taken over without modification.

For the write operation, one of the two ports is given a higher priority, for example; that is, a situation in which both ports write simultaneously is prevented. Only after the preferred port has executed the write operation may the other port write. In some instances, only one processor has write authorization for accordingly assigned memory areas. In the same way, during any write operation to a memory cell it is possible to prevent the respective other port from reading the same memory cell, or the read operation may be delayed by stopping the processor making the read request until the write operation is completed. For this purpose, an address comparator, shown in FIG. 2, of all address bits (251) having a corresponding arbiter 252 is provided that also evaluates the control signals of the processors and forms output signals 213 and 223 that control these sequences. In an advantageous embodiment, output signals 213 and 223 may each assume at least three signal states, enable, wait, and equal, where enable permits access, wait is designed to delay access, and equal indicates that the same memory area is being accessed by both ports. For a pure instruction cache, a write access is not necessary; in this case, a signal state equal for output signals 213 and 223 suffices.

In the event of a cache miss, the datum or the instruction must be loaded from a program or data memory via the bus system. The incoming data are forwarded to the processing unit and are written to the cache in parallel together with the identifier and the control bits. Here too the address comparator prevents the repeated loading of the datum from the memory when no hit exists but an equal signal (component or state of 213 and 223) is indicated by the address comparator. In the case of reading from both sides, the equal signal is formed only from the significant address bits, because the entire block is always loaded from the memory. The waiting processing unit may access the cache only after the block is stored in the cache.

In an additional advantageous embodiment, two separate dual-port caches for data and for instructions are provided; in the latter normally no write operations must be provided. In this case, the address comparator always checks only the parity of the significant address bits and provides the relevant control signal “equal” in signals 213 and 223.

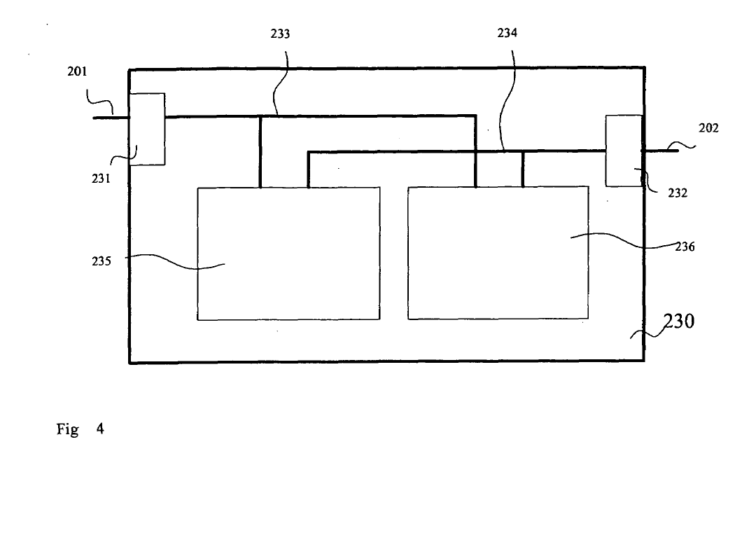

Furthermore, it is possible that simultaneous read access by both ports functions without restriction only when the requested data exist in different address areas that enable the simultaneous access. Consequently, expenditures may be reduced in the hardware implementation since not all access mechanisms have to be duplicated in the memory. For example, the cache may be implemented in multiple partial memory areas that may be operated independently of one another. Every partial memory enables via select signals only the processing of one port. In FIG. 4, one such memory 230 is shown that contains two partial memory areas 235 and 236. In the exemplary embodiment shown here, two select signals E₀ and E₁ are formed from an address bit Aᵢ such that for the case Aᵢ=0, E₀=1 and E₁=0 are valid, and for the case Aᵢ=1, E₀=0 and E₁=1 are valid. The two select signals and the less significant address bits Aᵢ₋₁ . . . A₀ are then contained in signals 233 and 234.

For an additional exemplary embodiment having four partial memories, the four select signals may be generated from two address bits since every partial memory serves uniquely one specific address area. In this way, four partial memory areas may be accessed, for example, using the two address bits Aᵢ₊₁ and Aᵢ by generating the four select signals E₀ to E₃ according to the binary significance according to Table 1.

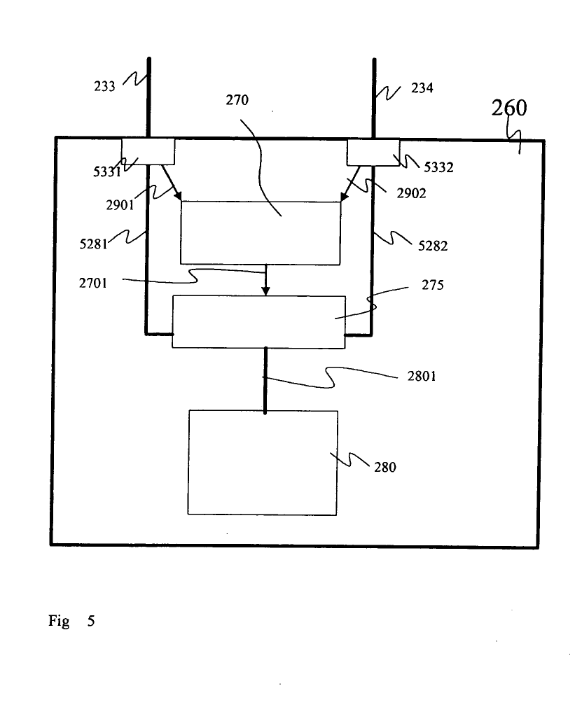

For the partial memories 235 and 236 shown in FIG. 4, an exemplary embodiment is shown in FIG. 5. The partial memory labeled 260 in the latter is in this particular embodiment executed as a single-port RAM 280 whose addresses, data, and control signals are switched over depending on the request. The switchover is performed by a control circuit 270 with the aid of a multiplexer 275, as a function of the select signals and other control signals 2901 or 2902 (for example, read, write) from the respective ports. These signals are contained, together with the data and addresses, in signals 233 and 234, and are routed via 5281 and 5282 to multiplexer 275, which depending on the decision of control circuit 270 connects according to output signal 2701 either 5281 or 5282 to signals 2801. This example assumes, without restricting the generality, a direct addressing of the cache (direct-mapped). If a multi-associative cache organization exists, either the comparison for validity must take place in units 275 and the cache hit signal must be forwarded to the port, or all data are forwarded via port 5331 and signal 233 to 231 or via port 5332 and signal 234 to 232, where the validity is checked.

In this context, the control circuit may carry out the relaying of signals 5281 or 5282 to 2801 and thereby to single-port RAM 280 and also forward the data and other signals from 280 in the opposite direction. This occurs as a function of a valid select signal and of signals 233 and 234 and/or of the sequence in which the ports cause a read or write operation with memory 280 via these signals. If the read or write signals become simultaneously active in signals 233 and 234, then a previously defined port is served first. This preferred port remains connected to 2801 even when no read or write signal is active. Alternatively, the preferred port may also be defined dynamically by the processor system, which may be as a function of information regarding the state of the processor system.

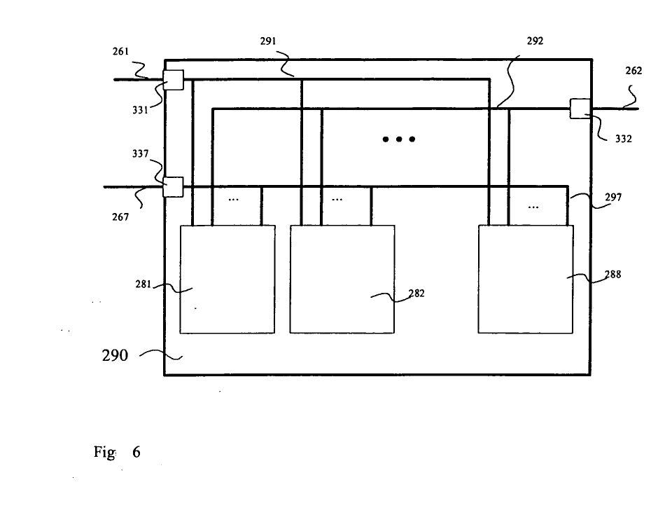

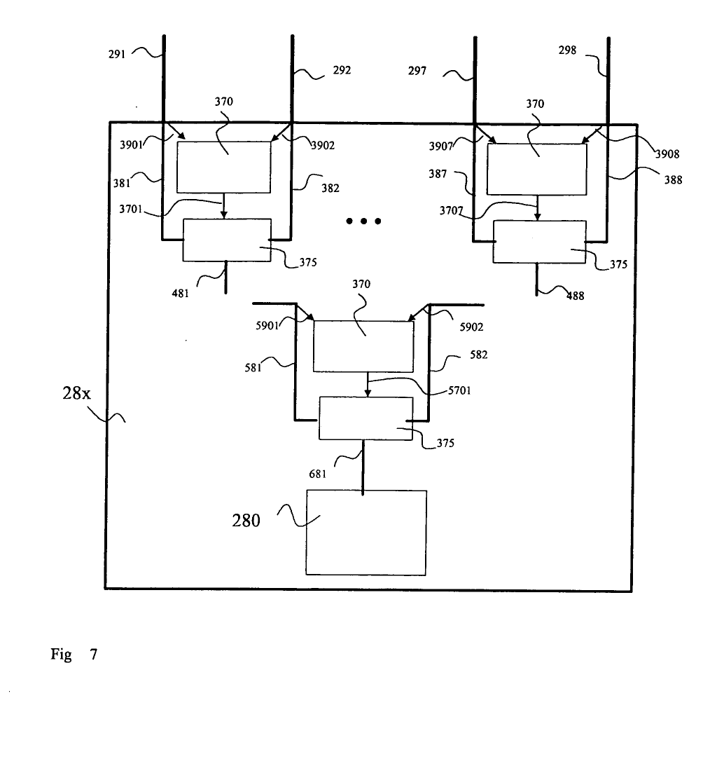

This arrangement having a single-port RAM is more cost-effective than a dual-port RAM having a parallel access possibility; however, it delays the processing of at least one processing unit when a partial memory is simultaneously accessed (even by read-access). Depending on the application, it is now possible to carry out different divisions of the RAM subsections such that in conjunction with the design of the instruction sequences and the data accesses from the different processing units as few simultaneous accesses as possible occur to the same RAM subsections. This arrangement may also be extended to include accesses by more than two processors: A multi-port RAM may also be implemented in the same way if the switchover of the addresses, data, and control signals is provided in sequential steps via multiple multiplexers (FIGS. 6 and 7).

Such a multi-port RAM 290 is shown in FIG. 6. There port input signals 261, 262, . . . 267 are decoded to form signals 291, 292 . . . 297 in decoding devices 331, 332, . . . 337. This decoding generates the select signals for the accesses to the individual RAMs in 281, 282 and 288. FIG. 7 shows in more detail an exemplary embodiment for a partial memory 28x (281 . . . 288). There, in a first stage of control devices 370, select signals and control signals 3901, 3902, . . . 3908 are processed from control signals 291, 292 . . . 298 to form output signals 3701, . . . 3707. These output signals each trigger one multiplexer 375 that, depending on the signal value, establishes the connections of buses 381 or 382, up to 387 or 388 to signals 481 . . . 488. In additional stages, similar control devices 370 and multiplexers 375 are correspondingly switched until, in a last stage, signals 5901 and 5902 are used for the control device. Output signal 5701 then connects either 581 or 582 to 681, which is connected to the single port RAM.

In contrast to multiplexers 275 from FIG. 5, multiplexers 375 from FIG. 7 connect in addition to the address, data, and control signals also the select signals of the next stages that are contained in 381, 382 . . . 388. Furthermore, comparators may be contained in 375 that, for a multi-associative addressing type, determine the validity of the data that were read from the subsections.

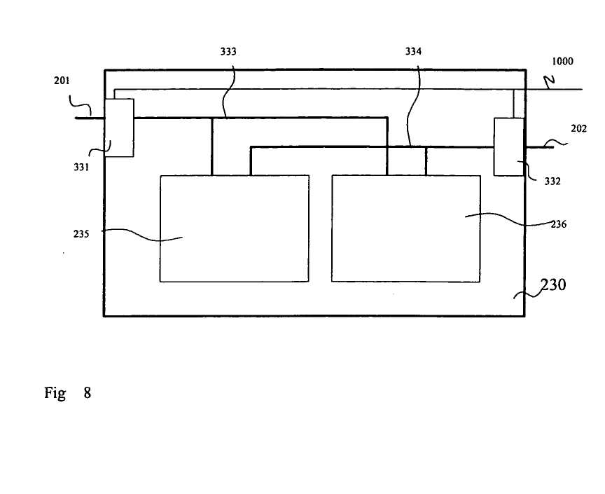

In an additional advantageous embodiment, the connection of RAM areas to different processing units may be made dependent on one or multiple system states or configurations. To that end, FIG. 8 illustrates an example of a configurable dual-port cache. For this purpose, system mode or configuration signal 1000 is used for decoding the input signals for each of the two ports. Table 2 shows a possibility for changing the decoding as a function of this signal 1000, which is labeled M in the table. If M=0, then a compare mode exists, for example, in which both ports have access to the entire cache. If this becomes M=1, however, (for example, performance mode), then each port has access only to half of the cache, but every port may access this area without restriction (without influencing the activities at the other port). In this mode, the address bit Aᵢ is not used for addressing the cache (in direct-mapped mode), but rather data whose addressing differs only with regard to this bit are stored in the same place in the cache. Only when the cache content is read is it then possible to find out, on the basis of the identifier, whether it is the sought datum, and the cache-hit signal may be generated accordingly. Depending on where the relevant comparator is situated, the data, including identifier and control bits, are to be output via signals 291, 292, . . . 297 to ports 331, 332, . . . 337 and further to signals 261, 262, . . . 267. It is also possible to allow only port 1 access to the entire cache in the performance mode (M=1). This embodiment is shown in Table 3. The user may also divide the cache in any other way by using multiple configuration signals. For a larger cache area, this allows on the one hand a higher hit rate, thereby reducing the need to load data from the main memory. On the other hand, the different processing units do not interfere with each other when to the greatest extent possible only cache areas that are independent of each other are accessed via the ports. Since these conditions are dependent on the programs intended for application, it is advantageous if, depending on the application, the possibility of another configuration exists. On the other hand, when the system state changes (compare mode/performance mode), the cache may be switched over automatically by mode signal 1000.

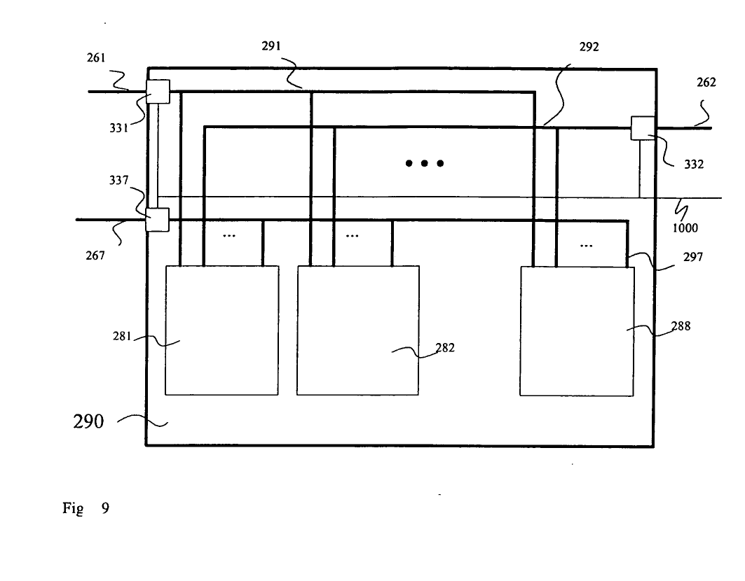

In FIG. 9, this possibility of switching the ports as a function of a mode or configuration signal is extended to a multi-port cache 290. In this instance, 331, 332, . . . 337 are the ports that control, with the aid of this mode or configuration signal, the connection of different partial RAM areas 281, 282, . . . 288. This control is guaranteed by select signals that are correspondingly generated in the ports and that are contained in signals 291, 292, . . . 297.

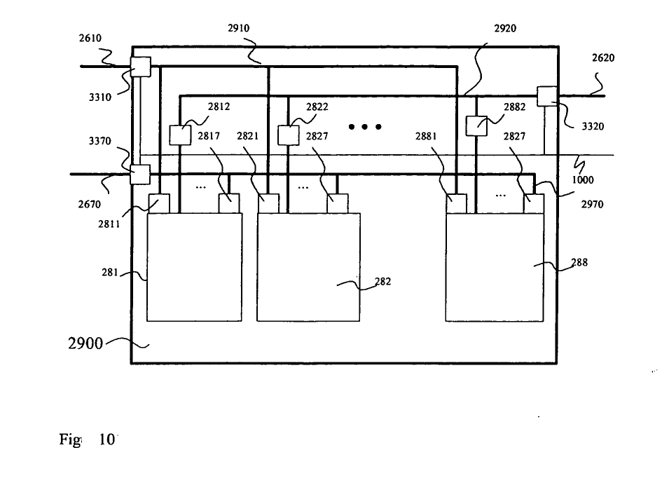

A further variant is shown in FIG. 10 when a multi-associative cache exists in which the data, together with the identifier and the control bits, are read back from every partial memory 281, 282, . . . 288. The validity is then checked in comparators 2811, 2812, . . . 2817, 2821, 2822, . . . 2827, . . . 2881, 2882, . . . 2887, and as a function of this the datum is forwarded together with the validity signals in signals 2910, 2920 . . . 2970. A switchover through mode or configuration signals is in this instance optionally just as feasible, as already shown and explained in FIG. 9. The validity signals and if indicated mode and configuration signals 1000 are evaluated in ports 3310, 3320, . . . 3370 and the corresponding valid datum is forwarded with the cache hit signal or the cache miss signal to signals 2610, 2620, . . . 2670.

Instead of a RAM memory, the arrangement according to the exemplary embodiments and/or exemplary methods of the present invention may also be produced using other memory technologies such as MRAM, FERAM, or the like.

TABLE 1

| Aᵢ₊₁ | Aᵢ | E₃ | E₂ | E₁ | E₀ |
|---|---|---|---|---|---|
| 0 | 0 | 0 | 0 | 0 | 1 |
| 0 | 1 | 0 | 0 | 1 | 0 |
| 1 | 0 | 0 | 1 | 0 | 0 |
| 1 | 1 | 1 | 0 | 0 | 0 |

TABLE 2

| | | select- | select- | select- | select- |
|---|---|---|---|---|---|
| | | Signal E₁ | Signal E₀ | Signal E₁ | Signal E₀ |
| M, 1000 | Aᵢ | (Port1, 331) | (Port1, 331) | (Port2, 332) | (Port2, 332) |
| 0 | 0 | 0 | 1 | 0 | 1 |
| 0 | 1 | 1 | 0 | 1 | 0 |
| 1 | 0 | 1 | 0 | 0 | 1 |
| 1 | 1 | 1 | 0 | 0 | 1 |

TABLE 3

| | | select- | select- | select- | select- |
|---|---|---|---|---|---|
| | | Signal E₁ | Signal E₀ | Signal E₁ | Signal E₀ |
| M, 1000 | Aᵢ | (Port1, 331) | (Port1, 331) | (Port2, 332) | (Port2, 332) |
| 0 | 0 | 0 | 1 | 0 | 1 |
| 0 | 1 | 1 | 0 | 1 | 0 |
| 1 | 0 | 0 | 1 | 0 | 1 |
| 1 | 1 | 1 | 0 | 0 | 1 |

1-32. (canceled)

33. A device for storing at least one of data and instructions in a computer system having at least two processing units and at least one first memory area for the at least one of data and instructions, comprising:
a second memory area; and
a cache memory system and equipped with at least two separate ports;
wherein the at least two processing units accessing via these ports identical or different memory cells of the second memory area, and wherein the at least one of data and instructions from the first memory system are stored temporarily in blocks.

34. The device of claim 33, wherein a read access to a memory cell occurs simultaneously via the at least two ports.

35. The device of claim 33, wherein a read access to two different memory cells occurs simultaneously via the at least two ports.

36. The device of claim 33, wherein, in the event of a simultaneous read access to one same or two different memory cells via the at least two ports, access is delayed via the one port until access via the other port has concluded.

37. The device of claim 33, access addresses on the at least two ports are compared.

38. The device of claim 33, wherein a write access to a memory cell or a memory area via a first port is detected, and at least one of the write and the read access to the memory cell is at least one of prevented and delayed via the second port until the write access via the first port has ended.

39. The device of claim 33, wherein in the event of a read access via at least one port, it is checked whether requested data exist in the second memory area.

40. The device of claim 33, wherein an addressing arrangement addresses the first memory area and transfers blocks of memory content from the latter to the second memory area if the data requested via a first port do not exist in the second memory area.

41. The device of claim 40, wherein an address comparator determined that at least one memory cell from the memory block requested by the first processing unit via the first port is to be accessed via a second port.

42. The device of claim 41, wherein access is enabled to the memory cell only when the data in the second memory area are updated.

43. The device of claim 33, wherein the second memory area is subdivided into at least two address areas that may be at least one of read and written independently of each other.

44. The device of claim 43, wherein an address decoder generates select signals that, in the event of a simultaneous access via multiple ports to an address area, permit only one port access and prevent or delay the access of the at least one additional port, through wait signals.

45. The device of claim 44, wherein there are more than two ports, mutually independent address areas being accessed via selection devices having multiple stages, select signals being transmitted via the stages.

46. The device of claim 43, wherein at least one mode signal switches the access possibilities of the different ports.

47. The device of claim 43, wherein at least one configuration signal switches the access possibilities of the different ports.

48. The device of claim 43, wherein an n-fold associative cache is implemented with n different address areas.

49. The device of claim 33, wherein in the event of a write access to a memory cell of the second memory, the datum is written to the first memory area simultaneously.

50. The device of claim 33, wherein, in the event of a write access to a memory cell of the second memory, the datum is written to the first memory area after a delay.

51. A method for storing at least one of data and instructions in a computer system having at least two processing units and at least one first memory area for the at least one of data and instructions, the method comprising:
providing a second memory area as a cache memory system, equipped with at least two separate ports;
accessing, using the at least two processing units via the ports, one of identical and different memory cells of the second memory area, the at least one of data and instructions from the first memory system being stored temporarily in blocks.

52. The method of claim 51, wherein for at least one of reading data from the second memory area and writing data to the second memory area, processing units access in parallel via the two ports one of the same memory cells and different memory cells of the second memory area and read an identical memory cell via both ports simultaneously.

53. The method of claim 51, wherein addresses that are applied on both ports are compared.

54. The method of claim 51, wherein a write access to the second memory area is detected via a first port, and the write access and read access via a second port to this second memory area is at least one of prevented and delayed until the write access via the first port is finished.

55. The method of claim 51, wherein in the event of a read access via at least one port, the system checks whether the requested at least one of data and instructions exist in the second memory area.

56. The method of claim 55, wherein the check is performed with the address information.

57. The method of claim 55, wherein in the event that the data requested via a first port are not available in the second memory area, the system causes the relevant memory block to be transferred from the first memory arrangement to the second memory area.

58. The method of claim 55, wherein all information regarding the existence of the at least one of data and instructions are updated as soon as the requested memory block has been transferred to the second memory area.

59. The method of claim 55, wherein an address comparator ascertains that a second processing unit wants to access at least one memory cell from the memory block requested by the first processing unit.

60. The method of claim 59, wherein the access to the above-mentioned memory cell may occur when the relevant information about the existence of the at least one of data and instructions has been updated.

61. The method of claim 51, wherein the second memory area is subdivided into at least two address areas, and the at least two address areas may be at least one of read and written independently of each other via the at least two ports of the second memory area, each port being able to access each address area.

62. The method of claim 61, wherein concurrent access to one address area is restricted to exactly one port and all additional requests to access this address area via other ports are prevented or delayed while the first port is accessing it through wait signals.

63. The method of claim 51, wherein in the event of a write access to a memory cell or a memory area of the second memory, the datum to be written is written to the first memory area simultaneously.

64. The method of claim 51, wherein in the event of a write access to a memory cell or a memory area of the second memory, the datum to be written is written to the first memory area after a delay.
